(19) United States
(12) Patent Application Publication
(10) Pub. No.: US 2012/0089441 A1
(43) Pub. Date: Apr. 12, 2012

(54) IMAGING PRODUCT LAYOUT METHOD

(76) Inventor: Brian J. McCloskey, Carlsbad, CA (US)

(21) Appl. No.: 12/902,176

(22) Filed: Oct. 12, 2010

(51) Int. Cl. G06Q 30/00

(52) U.S. Cl. 705/14.1; 705/14.45

(57) ABSTRACT

A method of providing communications to groups of people includes forming a group of people, communicating a product offering to each person in the group, each communication including response information for purchasing the product, using a processor and communication network to identify people in the group that purchased the offered product without using the response information, and using a processor to count the number of persons in the group, the number of product purchases in response to the communication using the response information, and the number of identified people in the group to determine a communication favorability score.

### FIELD OF THE INVENTION

The present invention relates to a method for communicating with groups of people, and more particularly to commercial product-offering communications.

### BACKGROUND OF THE INVENTION

Commercial communications are common-place. Consumers frequently receive emails or direct-mail advertising promoting specific products. These promotions frequently include coupons or discounts for the promoted products. Companies that market the product are interested in the effectiveness of the communications and the likelihood that the communications will induce consumers to purchase the promoted products.

Conventional methods for tracking the effectiveness of promotional email communications include providing a code or hyperlink to a website. Any response from a consumer that includes the code or access to the hyperlink can be attributed to the promotional communication. Likewise, promotional communications that include coupons can be linked to the use of the coupon. Since codes, web-sites, and coupons can be unique to a specific promotion, the use of the codes, web-sites, or coupons can be directly linked to a promotional communication and the related promotion, providing a way to estimate the effectiveness of the communication.

U.S. Patent Application Publication No. 20070156513 describes an electronic coupon exchange network wherein a user requests and receives coupons. U.S. Patent Application Publication No. 20070192183 describes a database and a market intelligence engine that uses customer identification information to retrieve demographic data. U.S. Patent Application Publication No. 20080077499 describes the association of member identification, purchase data, and manufacturer items. U.S. Pat. No. 6,230,143 describes a system and method for analyzing coupon redemption data. While these can be useful techniques, it often happens that a consumer receives product promotional material, either electronically or on a physically printed medium and subsequently purchases the product as a result of the promotion but without using any of the unique identifiers associated with the promotional material. In this case, it is difficult for a company marketing the product to estimate the effectiveness of the promotional materials.

There is a need, therefore, for an improved method for determining the effectiveness of promotional material communication.

### SUMMARY OF THE INVENTION

According to a method of the present invention, communications to groups of people are provided, comprising:

(a) forming a group of people;

(b) communicating a product offering to each person in the group, each communication including response information for purchasing the product;

(c) using a processor and communication network to identify people in the group that purchased the offered product without using the response information; and

(d) using a processor to count the number of persons in the group, the number of product purchases in response to the communication using the response information, and the number of identified people in the group to determine a communication favorability score.

The present invention provides an improved method for communicating with groups of people for commercial purposes and for determining the effectiveness of promotional material communication.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 illustrates a computer-generated product-promotional communication to a customer useful in understanding a method of the present invention;

FIG. 2 illustrates a customer purchase of a product useful in understanding a method of the present invention;

FIG. 3 illustrates a customer registration of a product useful in understanding a method of the present invention;

FIGS. 4A-D illustrates a database analysis useful in understanding a method of the present invention;

FIG. 5 is a flow diagram illustrating a method of the present invention;

FIG. 6 is a flow diagram illustrating a method of the present invention;

FIG. 7 is a flow diagram illustrating another method of the present invention; and

FIG. 8 is an illustration of a computer system useful in accomplishing a method of the present invention.

### DETAILED DESCRIPTION OF THE INVENTION

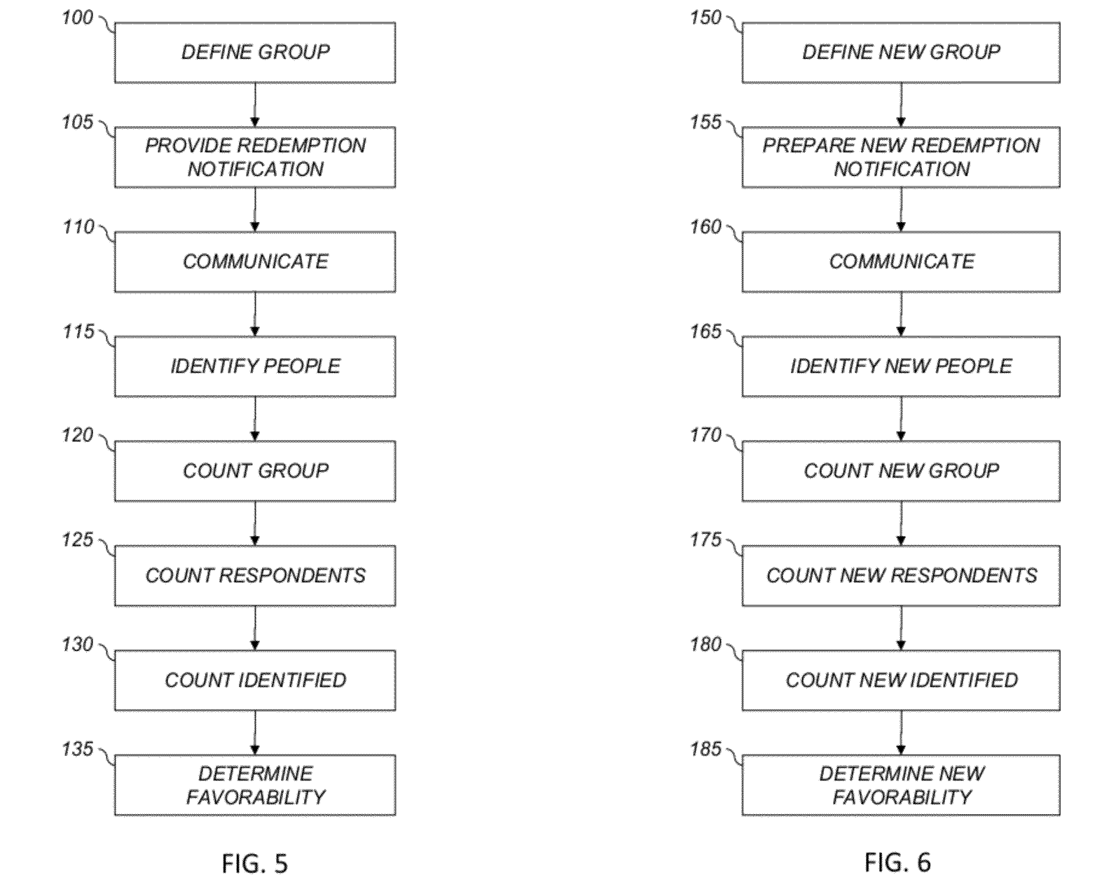

Referring to FIG. 5, a method of providing communications to groups of people includes forming a group of people in step 100. The group of people can be defined by attributes, for example by demographics, population statistics, income, interests, prior purchases, habits, or behaviors. In general, the group is selected based on interests to a commercial organization offering products of interest to the group.

In step 105 a redemption notification is optionally prepared. A redemption notification is a notice that can be redeemed by a customer in exchange for an item of value, for example a discount on a product, a product accessory, or an additional product feature or service. A redemption notification can be a coupon and can be provided in different ways according to different methods of the present invention, for example by printing on a media such as paper or by an electronic notification such as an email or access to a website from a hyperlink.

In step 110, a product offering is communicated to each person in the group, each product-offering communication including response information for purchasing the product. The response information can be a redemption notification and can be provided by redeeming the notice, for example by providing the optional coupon to the vendor of the product as part of a purchase process. As used herein, the response information is directly related to the product purchase and is provided at purchase by a customer.

In step 115, a processor and a communication network are used to identify people in the group that purchased the offered product without using the response information. This identification can be done by information provided by a product customer that is not part of the purchased product or purchasing process, for example, registration of a purchased product without using the response information.

The method of the present invention thus categorizes purchasers of an offered product who received the communication into three groups. A first group purchases the offered product and employs the response information to do so, for example by redeeming a notice such as a coupon. As is known in commercial industries, this group can be directly tracked by the product provider since the response information can be uniquely assigned to a customer and thus a product sale with the response notification can be attributed to that customer. A second group purchases the offered product but does not employ the response information. However, people in this group do take other steps, such as product registration, that permits the product provider to match the purchaser with the communication, thus permitting the product provider to identify people in the group that purchased the offered product without using the response information. Since product registration can include customer-identifying information and the original communication can include customer-identifying information, the registration and communication information can be cross-referenced to identify those people in the group who received the communication and response information, did not use the response information, but did purchase the offered product. The third group purchases the offered product but does not use the response information or provide any identifying information.

In step 120, the number of people in the group is counted. In step 125 the number of respondents (the first-group people who employed the response information) or the revenue from purchases made by the respondents is counted. In step 130, the identified people are counted (the second-group people who identified themselves without using the response information). In step 135, a communication favorability score is determined or a revenue effectiveness score is calculated.

The communication favorability score indicates the effectiveness of the communication. It can be computed, for example, as a simple ratio of the first group count plus the second group count, the sum divided by the number of people in the group. For example, if NumberPeople is the number of people in the group, Redemptions is the number of people who received the communication and purchased the offered product and employ the response information to do so, and Identifications is the number of people in the group who received the communication and purchased the offered product without using the response information but who identified themselves through alternative ways, such as product registration, then the communication favorability score FavoribilityScore can be determined as:

FavoribilityScore=(Redemptions +Identifications)/NumberPeople

The total revenue from the communication to the group is an alternative or additional indicator of the effectiveness of the communication. It can be computed by calculating the total revenue generated from purchases for which the actual purchase price is known, such as purchases from an on-line store, plus purchases where the actual purchase prices are unknown, such as retail. Total retail purchases are calculated by applying a standard purchase price to retail product registrations and using a historic ratio of product registrations from total retail product line sales to total retail sales. Average revenue per person is calculated by dividing the total revenue for a group by the total number of people in the group. Revenue is calculated for the group receiving the communication and can be compared to revenue for a control group of equivalent size that did not receive the communication. In embodiments of the present invention, a revenue effectiveness measure is also considered herein to be a favorability score.

Additional profits obtained as a result of the group communication can be calculated by calculating the profits for the products purchased by group members and then subtracting the profits for purchases from the control group members and subtracting the communication cost. Profits for a group are the revenue minus the costs for a purchased product.

The revenue effectiveness of the communication compared to other communications, or no communication, can be determined by calculating and comparing the revenue (or profit) per person in a group receiving the communication or the control group.

In a further embodiment of the present invention, a control group can be employed to measure the baseline group interest in a product offering independently of the product-offering communication. In this embodiment, a control group of people with similar attributes as the group of people is identified. Members of the control group do not receive the product-offering communication. The purchase rate of the control group of people for the product is measured by counting the number of purchases from members of the control group. This measure provides a “background rate” of product purchases that are not attributable to the product-offering communication and the background rate can be directly compared to the FavorabilityScore above. The comparison can be integrated into the metric, for example a DiscountedFavorabilityScore can be determined as:

DiscountedFavorabilityScore=((Redemptions +Identifications)/NumberPeople)−(ControlPurchase/ControlGroup)

where ControlPurchase is the number of people in the control group who purchase the product and ControlGroup is the number people in the control group. Note that in this case, the favorability score can be negative, indicating that the product-offering communication had the effect of discouraging purchases.

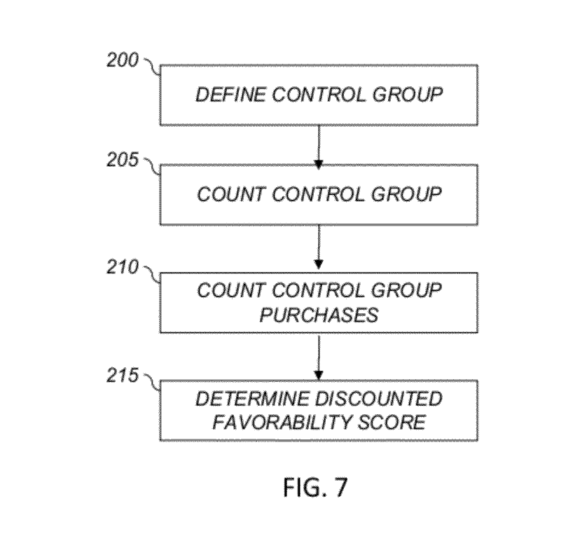

Referring to FIG. 7, in another embodiment of the present invention, a control group is formed in step 200. The control group is counted in step 205, and the control group purchases are counted in step 210. In step 215, a discounted favorability score is computed, as described above. As noted above, revenue effectiveness is also a favorability score and the calculation of a revenue effectiveness for a communication group compared to a control group is also a discounted favorability score.

Although the use of a redemption notification is optional, according to a method of the present invention, a redemption notification, such as a coupon, can be provided with the communication. The number of people in the communication that used the redemption notification to purchase the product can then be counted.

As noted, identification can be made by a purchaser through product registration. Such registration can be made in a number of different ways, according to various embodiments of the present invention. For example, a printed card provided with the purchased product can be sent to the product provider. In alternative examples, a purchaser can email, the product provider, register on-line, request help from the product provider, or provide comments to the provider about the product. Identifying information can be provided through the vendor, (e.g. a retailer distinct from the product provider), e.g. credit- or debit-card numbers.

Information used to generate the communication can be stored in a database in a computer-readable storage medium, for example by forming a database that includes a list of each person to whom a communication was sent or each identified person. The information can include a name, an address, a telephone number, an email, or a code associated with each person. Similarly, a record of the response information and identified people can be maintained in the database, and the number of people with qualifying attributes in the database counted and compared. In particular, people can be identified in the database by searching for identifying personal information (such as name, address, telephone number, or email address) and their associated record examined. When an identified person is found to have the attributes associated with the different groups described above, the person can be counted. Database methods for maintaining and searching lists of records with various attributes are well-known in the database and computing arts.

According to a further method of the present invention, the favorability score or revenue comparisons can be used to determine that a new communication should be written. If a favorability score or revenue comparison is relatively low, the communication can be deemed to be ineffective and a new communication prepared. Alternatively, a very high favorability score or revenue comparison can indicate that an incentive was stronger than necessary and a less costly communication or promotion considered. In this case, referring to FIG. 6, a new group is prepared in step 150. The new group can be the same as the group of step 100 (FIG. 5), or a different group, or can have some new people as well as some people from the group of step 100. A new redemption notification can be prepared in step 155 and communicated to the new group in step 160. The new communication can be the same communication sent to different people in the new group or can be a different communication, for example with a different message, employing a different medium, or employing different incentives in the redemption notification, such as a larger or smaller product discount.

People can be identified in step 165, the new group counted in step 170, the new respondents counted in step 175, the new identified people counted in step 180, and a new favorability score determined in step 185.

The communication process and evaluation described with reference to FIGS. 5 and 6 can be repeated as often as necessary or appropriate, using the same processes and tools, or different processes and tools.

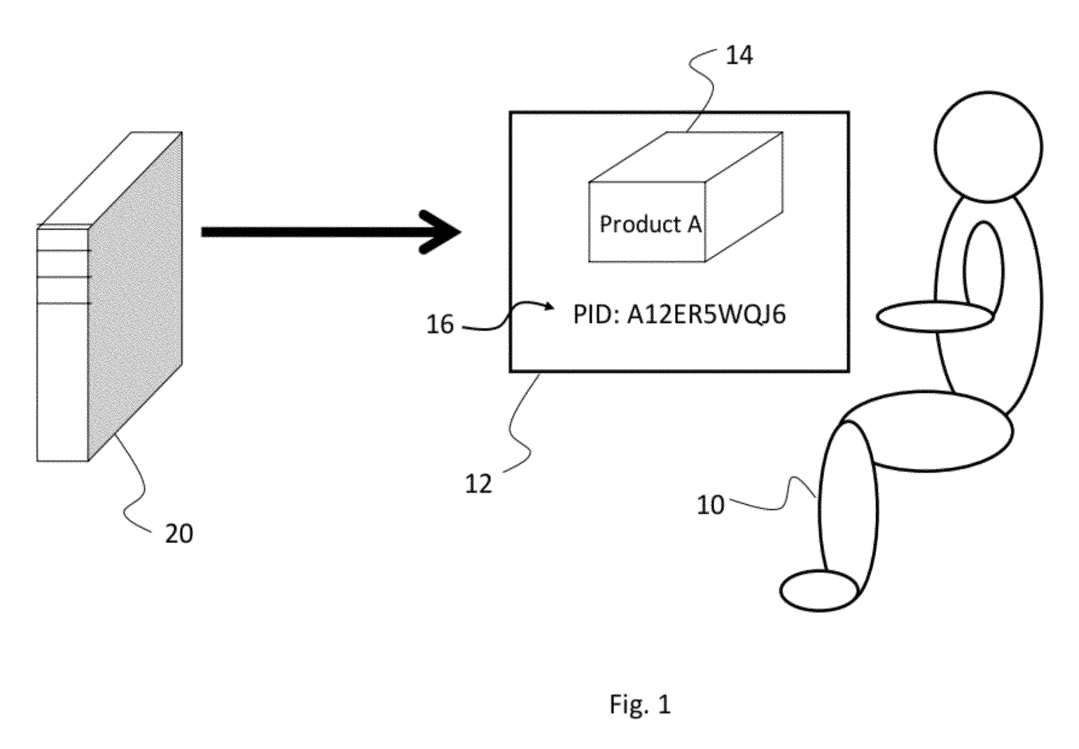

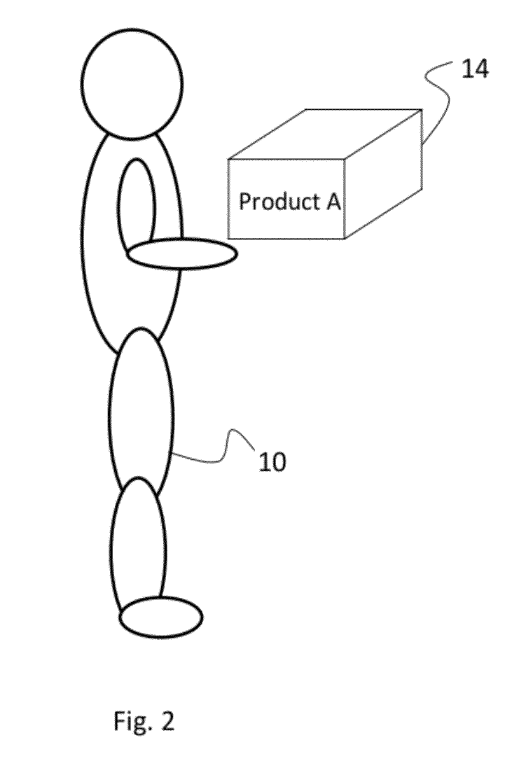

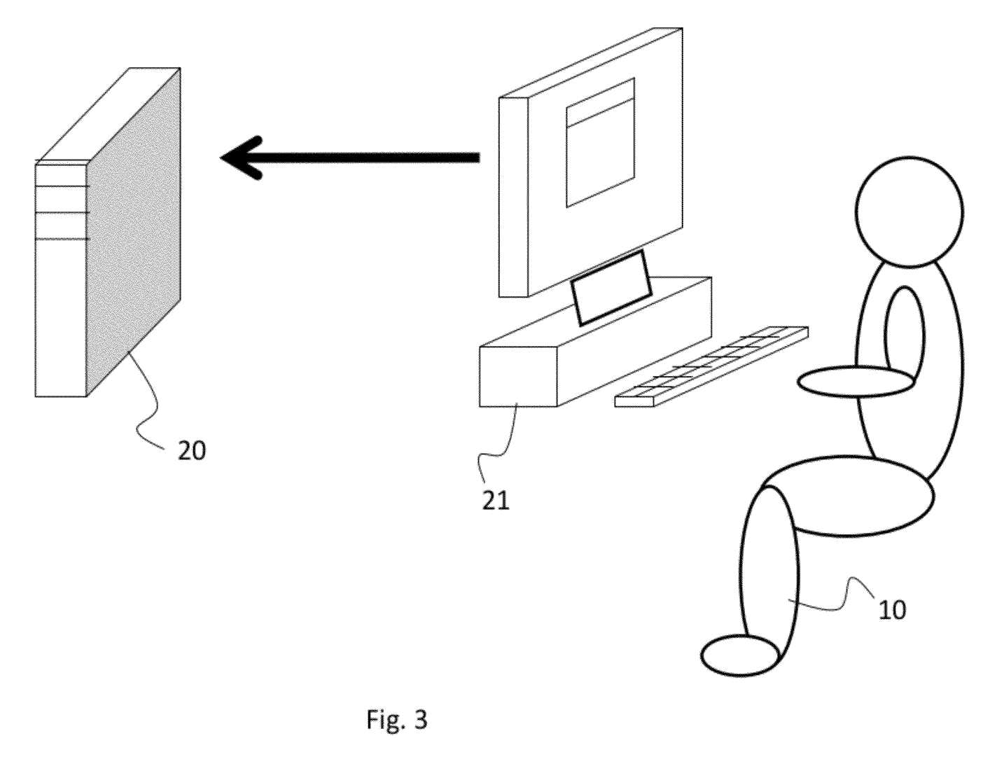

Referring to FIG. 1 and according to a method of the present invention, a customer 10 receives a communication 12, for example including a product 14 reference and a promotional identification 16, for example a coupon code on a coupon that can be redeemed for a product discount. The communication 12 is sent with the assistance of a provider-employed computer system 20, for example by email or by printing and mailing information on a medium, such as paper. Referring to FIG. 2, the customer 10 purchases the product 14, but does not employ the response information, for example does not use a redemption notification such as a coupon. However, as shown in FIG. 3, the customer 10 does subsequently communicate with the product provider, for example by registering the purchased product on-line, as indicated, by using a home computer 21 connected to a computer network, e.g. the internet, that is in turn connected to the computer system 20, either the same computer system 20 that is used to communicate or, more likely, a different computer system.

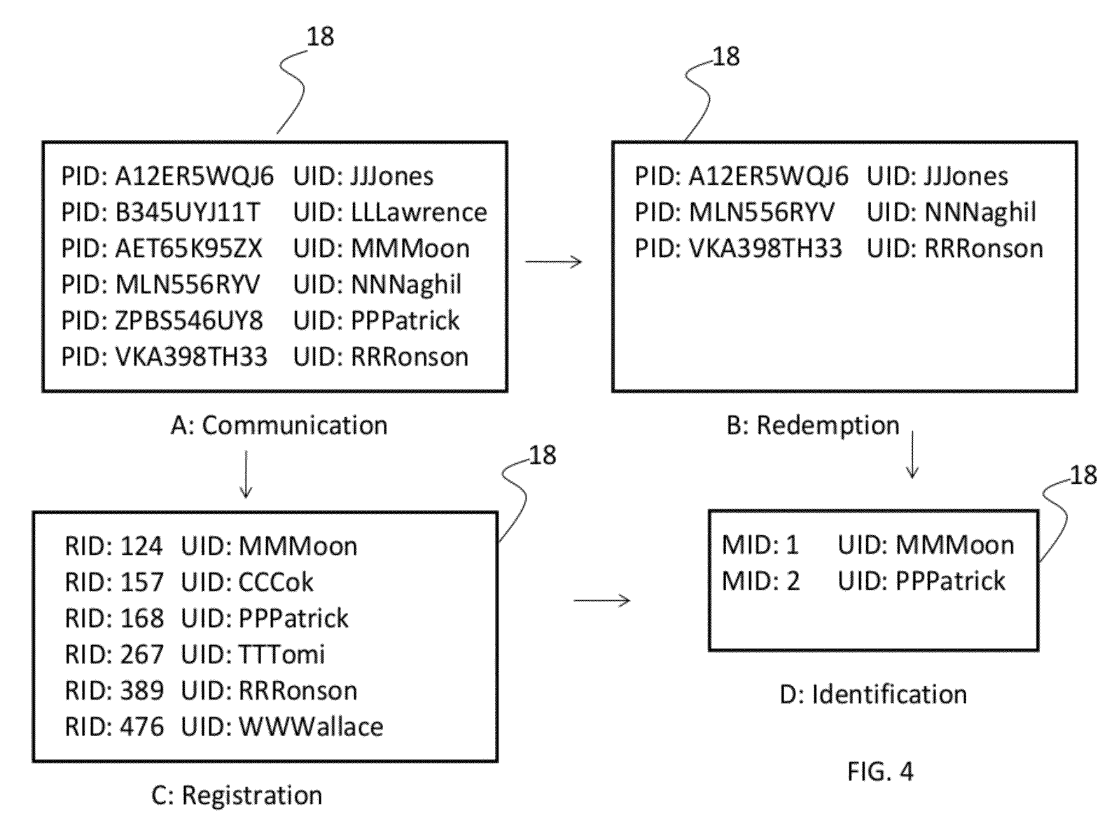

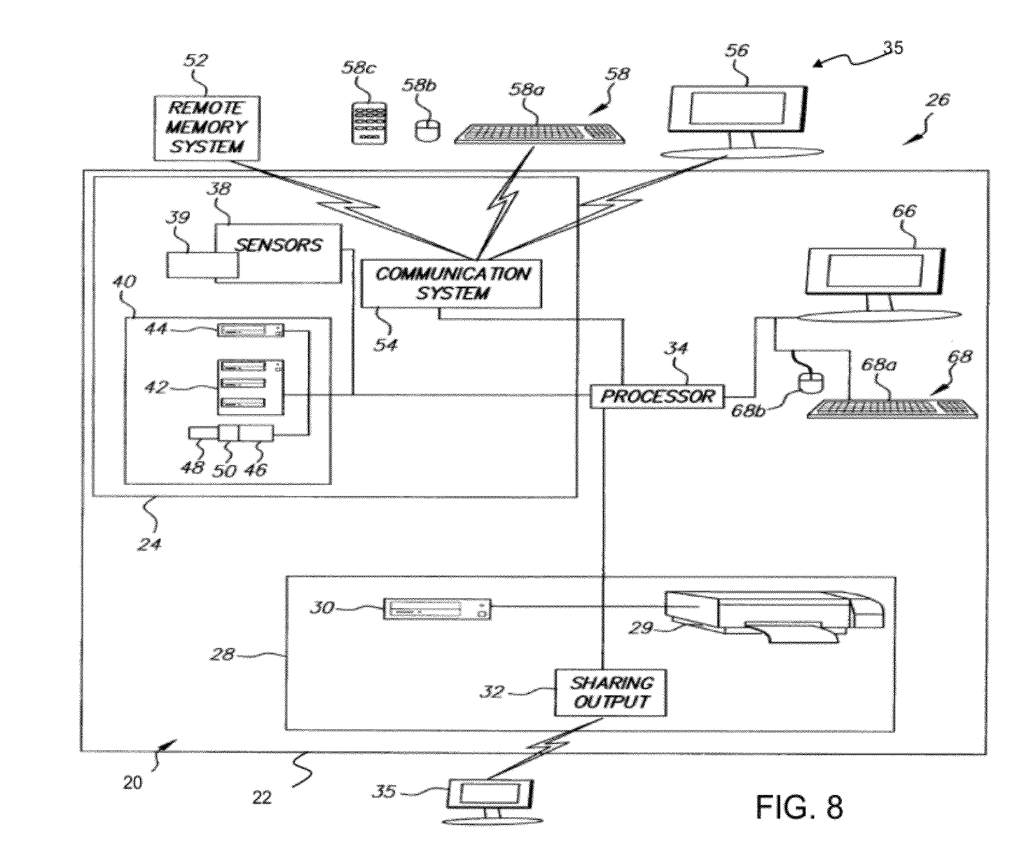

Referring to FIG. 4, the communication and response information can be stored in a database 18. As shown in FIGS. 4A-D, portions of the database information are shown. A list of people in the group that received a product-offering communication including response information is shown in FIG. 4A including names and a promotional identification (PID) number. After the communication some of the people in the group respond by purchasing the offered product and employed the response information to do so (FIG. 4B), for example by redeeming a communicated coupon. Since the respondents employed the response information, the response information (e.g. the promotional identification number) can be directly associated with the respondents, as indicated in illustration B. However, other of the people in the group can also purchase the offered product, do not employ the response information, but do subsequently identify themselves, for example through product registration identification (RID), as shown in illustration C. Furthermore, some people can purchase the offered product, but not in response to the communication. Some purchasers can both use the response information and identify themselves separately. By employing database operations, the people who identify themselves but do not employ the response information can be counted, for example by searching for the registration names (FIG. 4C) in the promotional identification list of the original communication (FIG. 4A) and removing any names found in the information response list (FIG. 4B) to yield the names shown in FIG. 4D, and counting them. While it is not always necessary to remove duplicate names found in both the product registration and the response information lists, doing so improves the accuracy of the result. The favorability index can be computed, for example by comparing the number of names in illustrations, FIGS. 4A, 4B, and 4D. In this illustrative case the favorability index equals (3+2)/6 or approximately 83%. Referring to FIG. 8, computers, computer servers, and a communication system are illustrated together with various elements and components that are useful in accordance with various embodiment of the present invention. FIG. 8 illustrates an embodiment of the computer system 20 that can be used to manage and implement the method of the present invention. In the embodiment of FIG. 8, computer system 20 includes a housing 22 and a source of content data files 24, for example the database 18 (FIGS. 4A-D) having information about customers and customer responses, a user-input system 26 and an output system 28 including a printer 29, a data writer 30, and a communication output for sharing images 32 connected to a processor 34. The source of content data files 24, user-input system 26 or output system 28 and processor 34 can be located within housing 22 as illustrated. In other embodiments, circuits and systems of the source of content data files 24, user-input system 26 or output system 28 can be located in whole or in part outside of housing 22.

The source of content data files 24 can include any form of electronic or other circuit or system that can supply digital data to processor 34 from which processor 34 can derive data for implementing the present invention. In this regard, the content data files can include, for example and without limitation, customer names, customer addresses, customer email addresses, customer residential addresses, promotional identification numbers, coupon numbers, and product registration numbers.

Memory 40 can include conventional memory devices including solid-state, magnetic, optical or other data-storage devices. Memory 40 can be fixed within computer system 20 or it can be removable. In the embodiment of FIG. 8, computer system 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including, but not limited to, control programs, digital images and metadata can also be stored in a remote memory system 52 such as a personal computer, computer network or other digital system. Remote memory system 52 can also include solid-state, magnetic, optical or other data-storage devices.

In the embodiment shown in FIG. 8, computer system 20 has a communication system 54 that in this embodiment can be used to communicate with an optional remote memory system 52, an optional remote display 56, and/or optional remote input 58. The optional remote memory system 52, optional remote display 56, optional remote input 58A can all be part of the home computer system 21 having an input station 58 having remote input controls 58 (also referred to herein as “remote input 58”), can include the remote display 56, and that can communicate with communication system 54 wirelessly as illustrated or can communicate in a wired fashion. In an alternative embodiment, a local input station including either or both of a local display 66 and local input controls 68 (also referred to herein as “local user input 68”) can be connected to communication system 54 using a wired or wireless connection. The communication system 54 can be connected to a computer network.

Communication system 54 can include for example, one or more optical, radio frequency or other transducer circuits or other systems that convert image and other data into a form that can be conveyed to a remote device such as remote memory system 52 or remote display 56 using an optical signal, radio frequency signal or other form of signal. Communication system 54 can also be used to receive data from a host or server computer or network (not shown), the remote memory system 52, or the remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful embodiment, the computer system 20 can provide web access services to remotely connected computer systems (e.g. remote systems 35) that access the computer system 20 through a web browser. Alternatively, remote system 35 can provide web services to computer system 20 depending on the configurations of the systems.

User-input system 26 provides a way for an operator of computer system 20 to provide instructions to processor 34. User-input system 26 can also be used for a variety of other purposes including, but not limited to, permitting a user to arrange, organize and edit content data files, execute programs, and to provide information about people, groups of people, and communications either to or from one or more people.

In this regard user-input system 26 can include any form of transducer or other device capable of receiving an input from a user and converting this input into a form that can be used by processor 34. For example, user-input system 26 can include a touch screen input, a touch pad input, a 4-way switch, a 6-way switch, an 8-way switch, a stylus system, a trackball system, a joystick system, a voice recognition system, a gesture-recognition system a keyboard, a remote control or other such systems. In the embodiment shown in FIG. 7, user-input system 26 includes an optional remote input 58 including a remote keyboard 58a, a remote mouse 58b, and a remote control 58c and a local input 68 including a local keyboard 68a and a local mouse 68b.

Processor 34 operates computer system 20 based upon signals from user-input system 26, sensors 38 including digital camera 39, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components. The computer system 20 of FIG. 7 can be employed to manage and implement the method of the present invention.

The present invention provides the advantage of improving the measurement of communication effectiveness by including those respondents to a communication that identify themselves separately from the communication. The effectiveness of the communication can be further compared to a control response from a group that does not receive the product-offering communication to more accurately measure the communication effectiveness.

The invention has been described in detail with particular reference to certain preferred embodiments thereof, but it will be understood that variations and modifications can be effected within the spirit and scope of the invention.

### PARTS LIST

10 customer
12 communication
14 product
16 promotional identification
18 database
20 system
21 home computer
22 housing
24 source of content data files
26 user-input system
28 output system
29 printer
30 data writer
32 images
34 processor
35 remote systems
38 sensors
39 digital camera
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display
68 local input
68a local keyboard
68b local mouse
100 form group step
105 provide redemption notification step
110 communicate step
115 identify people step
120 count group step
125 count respondents step
130 count identified step
135 determine favorability step
150 form new group step
155 prepare new redemption notification step
160 communicate step
165 identify new people step
170 count new group step
175 count new respondents step
180 count new identified step
185 determine new favorability step
200 form control group step
205 count control group step
210 count control group purchases
215 determine discounted favorability

1. A method of providing communications to groups of people, comprising:
(a) forming a group of people;
(b) communicating a product offering to each person in the group, each communication including response information for purchasing the product;
(c) using a processor and communication network to identify people in the group that purchased the offered product without using the response information; and
(d) using a processor to count the number of persons in the group, the number of product purchases in response to the communication using the response information, and the number of identified people in the group to determine a communication favorability score.

2. The method of claim 1, further including providing a redemption notification with the communication and counting the number of people in the communication that used the redemption notification to purchase the product.

3. The method of claim 1, wherein the identification is made by a product registration, a credit-card purchase, or a debit card purchase.

4. The method of claim 1, wherein the communication is an email.

5. The method of claim 1, wherein the communication is mail printed on a medium.

6. The method of claim 1, wherein the communication includes coupons.

7. The method of claim 1, further comprising forming a database that includes a list of each person to whom a communication was sent or each identified person.

8. The method of claim 7, wherein the database includes a name, an address, a telephone number, an email, or a code associated with each person.

9. The method of claim 1, further including using the favorability score to determine that a new communication should be written, writing a new communication, identifying new people in the group, and repeating steps (b) through (d) with the new people in the group and the new communication to determine a new communication favorability score.

10. The method of claim 9, further including providing a redemption notification with the new communication and counting the number of new people receiving the new communication that used the redemption notification to purchase the product.

11. The method of claim 9, wherein the personal identification is made by a product registration, a credit-card purchase, or a debit card purchase.

12. The method of claim 9, wherein the communication is an email.

13. The method of claim 9, wherein the communication is mail printed on a medium.

14. The method of claim 9, wherein the communication includes coupons.

15. The method of claim 9, further comprising forming a database that includes a list of each person to whom a communication was sent or each identified person.

16. The method of claim 15, wherein the database includes a name, an address, a telephone number, an email, or a code associated with each person.

17. The method of claim 1, further including forming a control group of people, the control group having group attributes similar to group attributes of the group of people.

18. The method of claim 17, further including using a processor to count the number of persons in the control group, the number of product purchases made by members of the control group, and comparing the number to the number of product purchases in response to the communication using the response information, and the number of identified people in the group to determine a discounted communication favorability score.
